(19) United States
(12) Patent Application Publication
(10) Pub. No.: US 2012/0258307 A1
(43) Pub. Date: Oct. 11, 2012

(54) Matte Multi-Layer Films Having Improved Sealing Properties

(76) Inventors: George F. Cretekos, Farmington, NY (US); Lori A. Frauenhofer, Fairport, NY (US)

(21) Appl. No.: 13/403,180

(22) Filed: Feb. 23, 2012

Related U.S. Application Data
(60) Provisional application No. 61/474,098, filed on Apr. 11, 2011.

(51) Int. Cl. B32B 27/08; B32B 17/10; B32B 37/08; B32B 37/24; B32B 37/06; B32B 27/34; B32B 15/08

(52) U.S. Cl. 428/341; 428/516; 428/476.9; 428/441; 428/451; 428/461; 428/447; 156/244.11

(57) ABSTRACT

Multi-layer structures including an oriented multi-layer polymeric film wherein the multi-layer film includes a heat sealable skin layer that includes a matte resin composition and 0.5 to <50.0 wt % of an elastomer selected from propylene based elastomers, ethylene-based elastomers and mixtures thereof, wherein the elastomer or mixture thereof has a Vicat softening temperature of >50° C.; wherein the heat sealable skin layer has a Haze >45.0 % and a 45° Gloss <20.0 and a core layer comprising a polypropylene homopolymer or mini-random copolymer in surface contact with the heat sealable skin layer are disclosed. Optionally, the multi-layer structures can also include a substrate in surface contact with the oriented multi-layer polymeric film. Methods of making such multi-layer structures and articles made therefrom are also disclosed.

### PRIORITY CLAIM

This application claims the benefit of and priority to U.S. Ser. No. 61/474,098, filed Apr. 11, 2011 which is referenced in its entirety.

### FIELD OF THE INVENTION

Disclosed herein are matte heat-sealable, multi-layer polymeric films having improved sealing properties. More specifically, this invention relates to such multi-layer polymeric films that include a polymeric sealant layer comprising a blend of incompatible polymers.

### BACKGROUND OF THE INVENTION

Polypropylene-based multi-layer films are widely used in packaging applications, such as flexible packaging for snack foods, dry food mixes, pet foods, and seeds. Such multi-layer films must have the ability to form reliable seals at relatively low temperature, often doing so in the presence of contamination in the seal region from the contents of the packaging.

It is often desirable for such films to also have a matte appearance. Such matte films generally have a low gloss level and a hazy appearance. The level of matte appearance is an aesthetic consideration and can be achieved by mixing incompatible polymers.

Multi-layer polyolefin films for packaging applications including a heat-sealable surface layer formed of a syndiotactic propylene polymer effective to produce a heat seal with itself at a sealing temperature <230° F. (110° C.) are also known. The use of metallocene-catalyzed butene-propylene copolymers for lowering the minimum seal temperature in matte sealable films has been reported as well.

Nevertheless, there remains a need in the industry for heat sealable packaging films with a matte appearance that provide an acceptable combination of seal strength, machinability, optical properties, and sealability at a variety of conditions. A reduction of the seal initial temperature or minimum seal temperature is particularly desirable for some of today's challenging packaging operations, such as laminations including a lap seal structure.

### SUMMARY OF THE INVENTION

In one aspect, embodiments of the invention provide a multi-layer structure, comprising: (a) an oriented multi-layer polymeric film, comprising: (i) a heat sealable skin layer comprising a matte resin composition and 0.5 to <50.0 wt % of a propylene- or ethylene-based elastomer; and (ii) a core layer comprising a polypropylene homopolymer or mini-random copolymer; and (b) optionally, a substrate in surface contact with the multi-layer polymeric film; wherein the structure has a Haze ≧45.0% and a 45° Gloss <20.0.

In another aspect, embodiments of the invention provide a method of making a heat sealable multi-layer structure, the method comprising: coextruding a multi-layer polymeric film comprising i) a heat sealable skin layer comprising a matte resin composition and 0.5 to <50.0 wt % of a propylene- or ethylene-based elastomer; and ii) core layer comprising a polypropylene homopolymer or mini-random copolymer; orienting the multi-layer polymeric film in the machine and/or transverse direction; and optionally, laminating a substrate to a side of the multi-layer polymeric film opposite the heat sealable skin layer. In some embodiments, the method may further include quenching the coextruded multi-layer polymeric film utilizing a chilled casting roll system or casting roll and water bath system.

In yet another aspect, embodiments of the invention provide articles comprising such multi-layer films and articles made by such methods.

These and other features, aspects, and advantages of the present disclosure will become better understood with regard to the following description and appended claims.

### DETAILED DESCRIPTION

Particular embodiments of the invention described herein are believed to provide sealing properties, e.g., minimum seal temperature, of films and laminated structures having a matte appearance. Selected embodiments of such films and laminated structures will now be described in more detail, but this description is not meant to foreclose other forms within the broader scope of this disclosure.

Each of the following terms written in singular grammatical form: “a,” “an,” and “the,” as used herein, may also refer to, and encompass, a plurality of the stated entity or object, unless otherwise specifically defined or stated herein, or, unless the context clearly dictates otherwise.

Each of the following terms: “includes,” “including,” “has,” ‘having,” “comprises,” and “comprising,” and, their linguistic or grammatical variants, derivatives, and/or conjugates, as used herein, means “including, but not limited to.”

Throughout the illustrative description, the examples, and the appended claims, a numerical value of a parameter, feature, object, or dimension, may be stated or described in terms of a numerical range format. It is to be fully understood that the stated numerical range format is provided for illustrating implementation of the forms disclosed herein, and is not to be understood or construed as inflexibly limiting the scope of the forms disclosed herein. For instance, all numbers disclosed herein are approximate values, regardless whether the word “about” or “approximate” is used in connection therewith. They may vary by 1%, 2%, 5%, and sometimes, 10 to 20%. Whenever a numerical range with a lower limit, R^{L} and an upper limit, R^{U}, is disclosed, any number falling within the range is specifically disclosed. In particular, the following numbers within the range are specifically disclosed: R=R^{L}+k*(R^{U}−R^{L}), wherein k is a variable ranging from 1% to 100% with a 1% increment, i.e., k is 1%, 2%, 3%, 4%, 5%, . . . , 50%, 51%, 52%, . . . , 95%, 96%, 97%, 98%, 99%, or 100%. Moreover, any numerical range defined by two R numbers as defined in the above is also specifically disclosed.

For the purpose of this description and the appended claims, the term “polymer” means a composition including a plurality of macromolecules, the macromolecules containing recurring units derived from one or more monomers. The term “polymer” includes macromolecules, such as copolymer, terpolymer, etc., and encompasses individual polymer components and blends thereof, e.g., physical blends, solution blends, and/or reactor blends.

The following definitions may aid in understanding the scope and meaning of certain terms herein.

The term “polyolefin” means a polymer containing recurring units derived from olefin, e.g., poly-α olefin such as polypropylene and/or polyethylene.

“Polypropylene” and “propylene-based” refer to a polyolefin containing recurring propylene-derived units, e.g., polypropylene homopolymer, polypropylene copolymer, etc., wherein >50%, preferably >70% or >85%, (by number) of the recurring units are derived from propylene monomer.

“Polyethylene” and “ethylene-based” refer to a polyolefin containing recurring ethylene-derived units, e.g., polyethylene homopolymer, polyethylene copolymer, etc., wherein >50%, preferably >70% or >85%, (by number) of the recurring units are derived from ethylene monomer.

As used herein, the term “isotactic” is defined as polymeric stereoregularity having at least 40% isotactic pentads of methyl groups derived from propylene according to analysis by ¹³C-NMR.

As used herein, “stereoregular” is defined to mean that the predominant number, e.g., >50%, >60%, >70%, or >80%, of the propylene units in the polypropylene or in the polypropylene continuous phase of a blend, such as impact copolymer exclusive of any other monomer such as ethylene, has the same 1,2 insertion and the stereochemical orientation of the pendant methyl group is the same, either meso or racemic.

“Copolymer” means a polymer containing recurring units derived from at least two different monomers, preferably, e.g., olefins, such as ethylene, propylene, butenes, etc. Thus, a propylene copolymer or propylene-based polymer contains at least two different monomers wherein >50%, preferably >70% or >85%, (by number) of the recurring units are derived from propylene monomer.

“Terpolymer” means a polymer containing recurring units derived from at least three different monomers, preferably, e.g., olefins, such as ethylene, propylene, butenes, etc. Thus, a propylene terpolymer or propylene-based terpolymer contains at least three different monomers wherein >50%, preferably >70% or >85%, (by number) of the recurring units are derived from propylene monomer.

As used herein, “intermediate” is defined as the position of one layer of the multi-layer film wherein said layer lies between two other identified layers. In some forms, the intermediate layer may be in direct contact with either or both of the two identified layers. In other forms, additional layers may also be present between the intermediate layer and either or both of the two identified layers.

As used herein, “substantially free” is defined to mean that the referenced film layer is largely, but not necessarily wholly, absent a particular component. In some forms, the layer is completely free of the particular component; however, in other forms, small amounts of the component may be present within the referenced layer as a result of standard manufacturing methods, including recycling of film scraps and edge trim during processing.

Embodiments of the invention provide a multi-layer structure suitable for applications where a sealable film with a matte finish and relatively low minimum seal temperature is desirable. Optionally, embodiments of the invention may also have improved seal temperature range. The multi-layer structure includes an oriented multi-layer polymeric film and optionally, a substrate in surface contact with the multi-layer polymeric film. The oriented multi-layer polymeric film can be of any design provided it includes a skin layer comprising a matte resin composition and 0.5 to <50.0 wt % of a propylene- or ethylene-based elastomer; and a core layer comprising a polypropylene homopolymer or mini-random copolymer. The substrate can be any suitable film substrate.

### Heat Sealable Skin Layer

The heat sealable skin layer of the multi-layer polymeric film, which forms at least part of the multi-layer structure described herein includes a matte resin composition and 0.5 to <50.0 wt % of a propylene- or ethylene-based elastomer.

The heat sealable skin layer typically includes >50.0 wt % of a matte resin. In some embodiments, the matte resin is present in amount of 65.0 to 98.0 wt %, 80.0 to 95.0 wt %, or 85.0 to 92.5 wt %.

The term “matte resin” refers to a composition having two or more morphological phases in the same state. Such resins are sometimes described as blends wherein one polymer forms discrete packets that are dispersed in a matrix of another polymer and may also be referred to as “heterogeneous” or “incompatible” blends. Matte resins also include co-continuous blends where the blend components are separately visible, but it is unclear which is the continuous phase and which is the discontinuous phase. Morphology of blend components can be determined using scanning electron microscopy (SEM) or atomic force microscopy (AFM). In the event the SEM and AFM provide different data, then the AFM data are used. By “continuous phase” is meant the matrix phase in a heterogeneous blend. By “discontinuous phase” is meant the dispersed phase in a heterogeneous blend. Such blends typically provide a film characterized by a relatively high haze and/or a relatively low gloss. Haze is measured by ASTM D-1003. Gloss is measured by ASTM D-2457 at an angle of 45 degrees. Typically the multi-layer structure has a Haze ≧45.0% and a 45° Gloss <20.0 (measured on the side of the film having the heat sealable skin layer). Particular films have a Haze of from 45.0 to 80.0, particularly 50.0 to 65.0, and a gloss of from 5.0 to 18.0, particularly 10.0 to 15.0.

### Matte Resin Compositions

Materials useful for matte resins include, but are not limited to, ethylene propylene copolymers and blends of incompatible polymers, such as ethylene propylene random copolymers, polypropylene homopolymers, high density polyethylene (“HDPE”), ethylene vinyl acetate (“EVA”), ethylene methyl acrylate (“EMA”), ethylene ethyl acrylate (“EEA”), ethylene propylene butylene terpolymers (“EPB”), propylene butylene copolymer (“PB”), and combinations thereof

Preferred matte resins are chosen in part because they contain polymers which contribute to the sealability of the film. For example, in the preferred forms, the matte resin is a blend of incompatible polymers wherein at least one of the polymers in the blend has good sealing properties. Thus, in preferred forms at least one polymer of the matte resin has a reduced melting temperature as compared to more crystalline polymers. This allows the matte resin to contribute to the matte surface of the multi-layer film and also to the sealability of the film. In particularly preferred forms, the matte resin comprises an EPB terpolymer.

The matte resin can be a blend of high density polyethylene resins and a predominately propylene based polymer (homopolymer, copolymer, or terpolymer). The matte resin may include blends of PE with different densities; such as, for example, a blend of HDPE with a density of ≧0.94 g/cm³ and a lower density polyethylene with a density of 0.92 g/cm³ or less.

Particular matte resins may include blends of a low molecular weight copolymer and/or terpolymer with a high molecular weight copolymer and/or terpolymer. For example, the matte resin may be formed by providing a blend of at least one higher molecular weight component and at least one lower molecular weight component. The higher molecular weight component is high density polyethylene (HDPE) in some embodiments. The ratio of higher molecular weight copolymer and/or terpolymer to lower molecular weight copolymer and/or terpolymer, may be in the range of 25:75 to 75:25 or 50:50 high molecular weight component to low molecular component.

Examples of suitable higher molecular weight copolymers and/or terpolymers include, but are not limited to, copolymers and terpolymers having a melt flow rate ≦8 dg/min, as measured by ASTM D 1238 under a load of 2.16 kg at 230° C. (230° C./2.16 kg), such as JPC XPM 7700, JPC XPM 7790, or JPC XPM 7800 series propylene terpolymers (Japan Polypropylene Corporation) or Total 8573 (Total Petrochemical Company). Examples of suitable lower molecular weight copolymers and/or terpolymers include, but are not limited to copolymers and terpolymers having a melt flow rate ≧10 dg/min.

Suitable HDPE may have a melt index <1.0 g/10 min or <0.5 g/10 min, as measured in accordance with ASTM D1238, under a load of 2.16 kg at 190° C. (190° C./2.16 kg). The HDPE may have a density in the range of about 0.940 g/cm³ to about 0.970 g/cm³, and a melting point of in the range of about 115° C. to about 140° C. For example, the HDPE may have a density in the range of 0.950 g/cm³ to 0.970 g/cm³, and a melting point in the range of 120° C. to 134° C.

In other embodiments, the matte resin may include a propylene-ethylene copolymer and an ethylene-propylene-butylene (EPB) terpolymer. In some embodiments, the propylene-ethylene copolymer and terpolymer are propylene-based polymers. The propylene-ethylene copolymer may be a blend of different kinds of propylene-ethylene copolymers.

In other embodiments, the matte resin may include two immiscible polyolefin copolymers. For example, the immiscible blend can include two or more ethylene-based polymers each having different densities. In one form, the blend comprises at least a first ethylene-based polymer having a density of at least 0.91 g/cm³ and a second ethylene-based polymer having a density different from the density of the first ethylene polymer. For example, the blend may comprise HDPE and LDPE and/or LLDPE. The ratio of the blend components may vary depending upon the polyethylene components of the blend and the desired characteristics of the layer. A blend, in which an equal proportion of each component is employed, such as a 50:50 blend, may be used.

Some suitable matte resins include blends of at least one EPB terpolymer and an ethylene-based polymer. The ethylene-based polymer may be a HDPE or may be a LDPE. In other forms, the matte resin is a blend of at least one EPB, at least one LDPE, and at least one HDPE, for example, such as a blend of ethylene-propylene-butylene-1 terpolymer, a high density polyethylene (0.95 g/cm³), and relatively smaller amount of a lower density polyethylene (0.92 g/cm³ or less).

### Propylene- or Ethylene-Based Elastomer

In addition to the matte resin, the heat sealable skin layer also includes 0.5 to <50.0 wt % of a propylene- or ethylene-based elastomer. In particular embodiments, the heat sealable skin layer includes 2.0 to 35.0 wt %, 5.0 to 20.0 wt %, or 7.5 to about 15.0 wt % of the propylene- or ethylene-based elastomer.

### Propylene-Based Elastomers

Preferably, the propylene-based elastomer has an isotactic propylene triad tacticity of from 65 to 95%, a melting point by DSC ≦110° C., a heat of fusion of from 5 to 50 J/g, and comprises:

(1) propylene-derived units in an amount of at least 75 wt %;

(2) ethylene-derived units in an amount of at least 6 wt %; based on the combined weight of components (1), (2), and (3); and

(3) optionally 10 wt % or less of diene-derived units, wherein each of the above amounts is based on the combined weight of components (1), (2), and (3). In certain embodiments, the propylene-based elastomer has a melting temperature (Tₘ) in the range of 50° C. to about 150° C., preferably in the range of about 55° C. to about 80° C.

Some propylene-based elastomers have a single-peak melting transition as determined by DSC. Some propylene-based elastomers have a primary peak melting transition from <90° C., with a broad end-of-melt transition from >110° C. The peak “melting point” (Tₘ) is defined as the temperature of the greatest heat absorption within the range of melting of the sample. However, the propylene-based elastomer may show secondary melting peaks adjacent to the principal peak, and/or the end-of-melt transition, but for purposes herein, such secondary melting peaks are considered together as a single melting point, with the highest of these peaks being considered the Tₘ of the propylene-based elastomer. Some propylene-based elastomers may not have a discernable melting peak.

The procedure for DSC determinations is as follows. About 0.5 grams of polymer is weighed out and pressed to a thickness of about 15-20 mils (about 381-508 μm) at about 140° C-150° C., using a “DSC mold” and Mylar™ as a backing sheet. The pressed pad is allowed to cool to ambient temperature by hanging in air (the Mylar is not removed). The pressed pad is annealed at room temperature (about 23° C.-25° C.) for about 8 days. At the end of this period, an about 15-20 mg disc is removed from the pressed pad using a punch die and is placed in a 10 μliter aluminum sample pan. The sample is placed in a differential scanning calorimeter (Perkin Elmer Pyris 1 Thermal Analysis System) and cooled to about −100° C. The sample is heated at about 10° C./min to attain a final temperature of about 165° C. The thermal output, recorded as the area under the melting peak of the sample, is a measure of the heat of fusion and can be expressed in Joules per gram (J/g) of polymer and is automatically calculated by the Perkin Elmer System. Under these conditions, the melting profile shows two (2) maxima, the maximum at the highest temperature was taken as the melting point within the range of melting of the sample relative to a baseline measurement for the increasing heat capacity of the polymer as a function of temperature.

Preferably, the propylene-based elastomer is essentially free of polymer units derived from C₄-C₁₀ α-olefins. (i.e., contains <1.0 wt % of units derived from an α-olefin comonomer other than propylene or ethylene). Particularly useful propylene-based elastomers are propylene-ethylene elastomers that are essentially free of units derived from butylene. Preferably, the propylene-based elastomer includes from 6.0 to 18.0 wt %, particularly 10.0 to 18.0 wt % ethylene-derived units, more particularly, 15.0 to 18.0 wt %, ethylene-derived units.

In certain embodiments, the propylene-based elastomers have a triad tacticity of three propylene units, as measured by ¹³C NMR, from >75%, or 80%, or 82%, or 85%, or 90%. In one embodiment, the triad tacticity is within the range from 50 to 99%, and from 60 to 99% in another embodiment, and from 75 to 99% in yet another embodiment, and from 80 to 99% in yet another embodiment, and from 60 to 97% in yet another embodiment. Triad tacticity is determined as follows: The tacticity index, expressed herein as “m/r”, is determined by ¹³C nuclear magnetic resonance (NMR). The tacticity index m/r is calculated as defined by H. N Cheng in 17 MACROMOLECULES 1950 (1984). The designation “m” or “r” describes the stereochemistry of pairs of contiguous propylene groups, “m” referring to meso and “r” to racemic. An m/r ratio of 1.0 generally describes a syndiotactic polymer, and an m/r ratio of 2.0 an atactic material. An isotactic material theoretically may have a ratio approaching infinity, and many by-product atactic polymers have sufficient isotactic content to result in ratios from >50. Embodiments of the propylene-based elastomer have a tacticity index m/r within the range from 4, or 6 to 8, or 10, or 12.

In certain embodiments, the propylene-based elastomers have a heat of fusion (H_{f}), determined according to the Differential Scanning calorimetry (DSC) procedure described herein, of <75.0, <65.0, <55.0, <50.0 J/g. In certain embodiments, the H_{f} value is within the range from 0.5, 1.0, or 5.0 J/g to 35.0, 40.0, 50.0, 65.0, 75.0 J/g.

In certain embodiments, the propylene-based elastomers have a percent crystallinity within the range from 0.5 to 40%, and from 1 to 30% in another embodiment, and from 5 to 25% in yet another embodiment, wherein “percent crystallinity” is determined according to the DSC procedure described herein. (The thermal energy for the highest order of polypropylene is estimated at 189 J/g (i.e., 100% crystallinity is equal to 189 J/g).) In another embodiment, the propylene-based elastomer has a percent crystallinity <40%, or 25%, or 22%, or 20%.

In certain embodiments, the propylene-based elastomers have a density within the range from 0.840 g/cm³ to 0.920 g/cm³, and from 0.845 g/cm³ to 0.900 g/cm³ in another embodiment, and from 0.850 g/cm³ to 0.890 g/cm³ in yet another embodiment, the values measured at room temperature per the ASTM D-1505 test method.

In certain embodiments, the propylene-based elastomers have a Shore A hardness (ASTM D2240) within the range from 10, or 20 to 80, or 90 Shore A. In yet another embodiment, the propylene-based elastomers possess an Ultimate Elongation >5.0×10²%, or 1.0×10³%, or 2.0×10³%; and within the range from 3.0×10²%, or 4.0×10²%, or 5.0×10²% to 8.0×10²%, or 1.2×10³%, or 1.8×10³%, or 2.0×10³%, or 3.0 X 10³% in other embodiments.

In certain embodiments, the propylene-based elastomers have a weight average molecular weight (Mw) value within the range from 2.0×10⁴ to 5.0×10⁶ g/mol, and from 5.0×10⁴ to 1×10⁶ g/mol in another embodiment, and from 7.0×10⁴ to 4.0×10⁵ g/mol in yet another embodiment. In another embodiment, the propylene-based elastomers have a number average molecular weight (Mn) value within the range from 4.5×10³ to 2.5×10⁶ g/mol, and from 2.0×10⁴ to 2.5×10⁵ g/mol in yet another embodiment, and from 5.0×10⁴ to 2.0×10⁵ g/mol in yet another embodiment. In yet another embodiment, the propylene-based elastomers have a z-average molecular weight (Mz) value within the range from 2.0×10⁴ to 7.0×10⁶ g/mol, and from 1.0×10⁵ to 7.0×10⁵ g/mol in another embodiment, and from 1.4×10⁵ to 5.0×10⁵ g/mol in yet another embodiment.

In certain embodiments, the propylene-based elastomers have a melt flow rate (“MFR,” ASTM D1238, 2.16 kg, 230° C.), <90, or <70, or <50, or <40, or <30, or <20, or <10 dg/min. In some embodiments, the lower limit on the MFR is 0.1, 0.5, 1.0, 5.0, 10.0, 20.0, 30.0, 40.0, 50.0, 70.0, or 90.0 dg/min in other embodiments.

In certain embodiments, a desirable molecular weight (and hence, a desirable

MFR) is achieved by visbreaking the propylene-based elastomers. “Visbroken propylene-based elastomers” (also known in the art as “controlled rheology” or “CR”) are copolymers that have been treated with a visbreaking agent such that the agent breaks apart the polymer chains. Non-limiting examples of visbreaking agents include peroxides, hydroxylamine esters, and other oxidizing and free-radical generating agents. Stated another way, the visbroken copolymer may be the reaction product of a visbreaking agent and the copolymer. In particular, a visbroken propylene-based elastomer is one that has been treated with a visbreaking agent such that its MFR is increased, in one embodiment by at least 10%, and at least 20% in another embodiment relative to the MFR value prior to treatment.

In certain embodiments, the molecular weight distribution (MWD) of the propylene-based elastomers is within the range from 1.5, or 1.8, or 2.0 to 3.0, or 3.5, or 4.0, or 5.0, or 10.0 in particular embodiments. Techniques for determining the molecular weight (Mn, Mz, and Mw) and molecular weight distribution (MWD) are as follows, and as by Verstate et al. in 21 MACROMOLECULES 3360 (1988). Conditions described herein govern over published test conditions. Molecular weight and molecular weight distribution are measured using a Waters 150 gel permeation chromatograph equipped with a Chromatix KMX-6 on-line light scattering photometer. The system is used at 135° C. with 1,2,4-trichlorobenzene as the mobile phase. Showdex™ (Showa-Denko America, Inc.) polystyrene gel columns 802, 803, 804, and 805 are used. This technique is discussed in LIQUID CHROMATOGRAPHY OF POLYMERS AND RELATED MATERIALS III 207 (J. Cazes ed., Marcel Dekker, 1981). No corrections for column spreading were employed; however, data on generally accepted standards, for example, National Bureau of Standards, Polyethylene (SRM 1484) and anionically produced hydrogenated polyisoprenes (an alternating propylene-ethylene copolymer) demonstrate that such corrections on Mw/Mn or Mz/Mw are less than 0.05 units. Mw/Mn is calculated from an elution time-molecular weight relationship whereas Mz/Mw is evaluated using the light scattering photometer. The numerical analyses can be performed using the commercially available computer software GPC2, MOLWT2 available from LDC/Milton Roy-Riviera Beach, Fla.

Particular propylene-based elastomers comprise (1) >80.0 wt % propylene-derived units; (2) 14.0 to about 18.0 wt % ethylene-derived units; and (3) <2.0 wt % of diene-derived units, wherein each of the above amounts is based on the combined weight of components (1), (2), and (3); a Vicat softening temperature of about 55° C. to about 65° C., a Shore A Hardness measured according to ASTM of 60 to 75 at 15 seconds and 23° C. (73° F.), a density of 0.855 g/cm³ to 0.875 g/cm³, an MFR at 230° C./2.16 kg of 1.5 to 4.5 g/10 min, and an elongation at break of ≧300%, preferably ≧500%, preferably ≧700%.

Propylene-based elastomers are also described in WO 05/049670, the disclosure of which is incorporated herein by reference in its entirety.

The propylene-based elastomers described herein can be produced using any catalyst and/or process known for producing polypropylenes. In certain embodiments, the propylene-based elastomers can include copolymers prepared according to the procedures in WO 02/36651; U.S. Pat. No. 6,992,158; and/or WO 00/01745. Preferred methods for producing the propylene-based elastomers are found in US Patent Application Publication 2004/0236042 and U.S. Pat. No. 6,881,800. Preferred propylene-based polyolefin polymers are available commercially under the trade names Vistamaxx™ (ExxonMobil Chemical Company, Houston, Tex., USA) and Versify™ (The Dow Chemical Company, Midland, Mich., USA). Suitable metallocene-catalyzed propylene-ethylene copolymers include ExxonMobil Chemical's Vistamaxx™ series of elastomers, particularly Vistamaxx™ 3020 (ethylene content: 10.5 wt %), Vistamaxx™ 3980 (ethylene content: 8.5 wt %), and Vistamaxx™ 6120 ethylene content: 16 wt %). Other suitable EP elastomers include DOW CHEMICAL VERSIFY elastomers, particularly grades DP3200.01 having an ethylene content of 9 wt %, and Mitsui Chemical's Notio™ series having Tm about 100° C. or greater, such as, PN-2070, PN-3560, PN-0040, and PN-2060.

In one embodiment, the propylene-based elastomer includes 8.0 to 17.0 wt % units derived from ethylene and has a density of 0.860 g/cm³ to 0.890 g/cm³, an MFR of from 1.5 to 10.0 g/10 min according to ASTM D1238 at 230° C. under a load of 2.16 kg, a Vicat softening point of 55.0 to 80.0° C., and is present in an amount of 10.0 to 20.0 wt % based on the total weight of components in the heat sealable skin layer.

### Ethylene-Based Elastomers

Suitable ethylene-based elastomers include copolymers comprising >50.0 wt % ethylene, and having up to 50 wt %, preferably 1 to 35 wt %, even more preferably 1 to 6 wt % of a C₃-C₂₀ comonomer. The ethylene-based elastomers preferably have a composition distribution breadth index (CDBI) above 90%, even more preferably above 95%. In another preferred embodiment, the ethylene-based elastomer has a density of 0.86 g/cm³ to 0.925 g/cm³ and a CDBI of over 90%, preferably between 95% and 99%. In another embodiment, the ethylene-based elastomer has a melt index of 0.1 to 100 dg/min, preferably 0.5 to 50 dg/min, more preferably 0.8 to 30 dg/min, according to ASTM D1238 at 190° C. under a load of 2.16 kg.

Composition Distribution Breadth Index (CDBI) is a measure of the composition distribution of monomer within the polymer chains and is measured by the procedure described in PCT publication WO 93/03093, published Feb. 18, 1993 including that fractions having a weight average molecular weight (Mw) below 15,000 are ignored when determining CDBI. For purposes of this invention a homopolymer is defined to have a CDBI of 100%.

The C₃ to C₂₀ olefin comonomers for the ethylene-based elastomers described above may be any polymerizable olefin monomer and are preferably a linear, branched, or cyclic olefin, even more preferably an alpha-olefin. Examples of suitable olefins include propylene, butylene, isobutylene, pentene, isopentene, cyclopentene, hexene, isohexene, cyclohexene, heptene, isoheptene, cycloheptene, octene, isooctene, cyclooctene, nonene, cyclononene, decene, isodecene, dodecene, isododecene, 4-methyl-pentene-1, 3-methyl-pentene-1, 3,5,5-trimethyl hexene-1. Suitable comonomers also include dienes, trienes, and styrenic monomers. Preferred examples include styrene, alpha-methyl styrene, para-alkyl styrene (such as para-methyl styrene), hexadiene, norbornene, vinyl norbornene, ethylidene norbornene, butadiene, isoprene, heptadiene, octadiene, and cyclopentadiene. Preferred comonomers for the copolymer of ethylene are propylene, butylene, hexene, and/or octene.

The ethylene-based elastomers described above may also contain termonomers and tetramonomers which may be one or more of the C₃ to C₂₀ olefins described above, any C₄ to C₂₀ linear, cyclic or branched dienes or trienes and any styrenic monomers, such as styrene, alpha-methyl styrene, or para-methyl styrene. Preferred examples include butadiene, pentadiene, cyclopentadiene, hexadiene, cyclohexadiene, heptadiene, octadiene, nonadiene, norbornene, vinyl norbornene, ethylidene norbornene, isoprene, and heptadiene.

In a preferred embodiment, the ethylene-based elastomers described above are metallocene polyethylenes (mPE's). The mPE homopolymers or copolymers may be produced using mono- or bis-cyclopentadienyl transition metal catalysts in combination with an activator of alumoxane and/or a non-coordinating anion in solution, slurry, high pressure, or gas phase. The catalyst and activator may be supported or unsupported and the cyclopentadienyl rings by may substituted or unsubstituted. Several commercial products produced with such catalyst/activator combinations are commercially available from ExxonMobil Chemical Company in Baytown, Tex. under the tradename EXACT™. For more information on the methods and catalysts/activators to produce such mPE homopolymers and copolymers see WO 94/26816; WO 94/03506; EPA 277,003; EPA 277,004; U.S. Pat. Nos. 5,153,157; 5,198,401; 5,240,894; 5,017,714; 5,324,800; 5,264,405; 5,096,867; 5,507,475; 5,055,438; CA 1,268,753; EPA 129,368; EPA 520,732; WO 92 00333; EPA 426 637; EPA 573 403; EPA 520 732; EPA 495 375; EPA 500 944; EPA 570 982; WO91/09882; and WO94/03506. Another suitable ethylene-based copolymer is Infuse™ olefin block copolymers (available from Dow Chemical).

In one embodiment, the ethylene-based elastomer includes units derived from butylene and has a density of 0.870 g/cm³ to 0.900 g/cm³, a melt index (according to ASTM D1238 at 190° C. under a load of 2.16 kg) of 1 to 10.0 dg/min, particularly, 2.0 to about 6.0 dg/min, and a DSC-melting point of 40.0 to 70° C., particularly 50.0 to 60° C., and is present in an amount of 5.0 to 15.0 wt % based on the total weight of components in the heat sealable skin layer.

### Core Layer

The core layer comprises a polypropylene homopolymer or mini-random copolymer and has a first side and a second side. The first side of the core layer is adjacent to, though not necessarily directly in contact with, the heat sealable skin layer. Preferably, the core layer has a thickness of approximately 13 μm to 240 μm. Typically, however, the core layer is between about 13 μm to 90 μm, preferably from about 10 μm to 25 μm, more preferably from 15 μm to 20 μm, exclusive of optional tie layers discussed below.

The term “mini-random copolymer” as used herein refers to a propylene-based copolymer comprising ≦3.0, particularly ≦1.0 wt % α-olefin comonomer-derived units. In particular embodiments, the mini-random copolymer is a propylene-based polymer that comprises ≦3.0, particularly ≦1.0 wt % ethylene-derived units. Polypropylene homopolymers and mini-random copolymers suitable for the core layer include isotactic polypropylene (“iPP”), high crystallinity polypropylene (“HCPP”), or syndiotactic polypropylene (“sPP”), and combinations thereof. The polymers may be produced by Ziegler-Natta catalyst, metallocene catalyst, or any other suitable means. Such propylene-based polymers will generally have a melting point of at least about 140° C., or at least 150° C. The melt flow rate (according to ASTM D1238 at 230° C. under a load of 2.16 kg) of the polypropylenes may be in the range of 0.5 to 8 or 1.5 to 5 g/10 min. Examples of commercially available propylene polymers include, but are not limited to, Total 3371 (Total Petrochemicals Company), or PP4712 (ExxonMobil Chemical Company).

In one form, the polypropylene homopolymer or mini-random copolymer is a high crystallinity polymer. A high crystallinity polymer may be desirable to maintain tensile strength of the film, which can be reduced by the presence of other layers. For example, the high crystallinity polymer enables the multi-layer film to maintain a stiffer modulus despite the softer more flexible polymers contained optional tie layers and/or the heat sealable skin layer. An example of a suitable commercially available HCPP is Total Polypropylene 3270, available from Total Petrochemicals.

In a particular form, the core layer comprises a HCPP with an isotacticity expressed in mmmm pentads of at least 97%, more preferably of at least 97.5%, as measured by ¹³C-NMR.

The core layer may further comprise at least one additive such as an opacifying agent, void-initiating particles, a hydrocarbon resin, or combinations thereof. An opacifying or coloring agent may be used in the core layer, e.g., silica, carbon black, aluminum, titanium dioxide (TiO₂), talc, and combinations thereof.

Cavitating or void-initiating particles may be added to the core layer polymer to create an opaque film. The cavitating or void-initiating additives include any suitable organic or inorganic material that is incompatible with the core layer polymer material at the temperature of biaxial orientation. Examples of suitable void-initiating particles are polybutylene terephthalate (PBT), nylon, solid or hollow pre-formed glass spheres, metal beads or spheres, ceramic spheres, calcium carbonate, talc, chalk, or combinations thereof.

The core layer may comprise anti-static agents or migratory slip agents, such as fatty amides.

In some embodiments, the core layer includes a first tie layer that forms the first side of the core layer and is in surface contact with the heat sealable skin layer. In some embodiments, the core layer includes a region that may be called a second tie layer. The second tie layer forms the second side/surface of the core layer. Where a second skin layer is present, the second tie layer is in surface contact with the second skin layer. These tie layers may include homo-, co-, or terpolymers comprising polypropylene, polyethylene, polybutylene, or blends thereof and may have a thickness of at least about 0.75 μm. The first side of the first tie layer is adjacent to the second side of the heat sealable skin layer; and the first side of the core layer is adjacent to the second side of the first tie layer. The second side of the second tie layer is adjacent to the first side of the second skin layer; and the second side of the core layer is adjacent to the first side of the second tie layer. Tie layers when present may be include the same or different additives as the core layer and may be voided in the same or different manner, or may not be voided.

Thus, independently of other regions of the core layer, the tie layer regions of the core, tie layer(s) may also include a conventional non-void-inducing filler or pigment such as titanium dioxide. Generally, from an economic viewpoint at least, it has not been considered to be of any particular advantage to use more than about 10 wt % of titanium dioxide.

The thickness of the first tie layer region is not critical and typically ranges from about 0.6 μm to about 8.0 μm, particularly 1.0 μm to 6.0 μm, or 2.0 μm to 4.0 μm. In general, the preferred thickness of the tie layer is based on the overall film thickness, the desired stiffness, and seal properties.

### Second Skin Layer

A second skin layer is optional and when present is provided on the opposite surface of the core layer from the heat sealable layer. The second skin layer has a first surface and a second surface, the first surface of the second skin layer is on the second surface of the core layer and may be contiguous to the second surface of the core layer or contiguous to one or more tie layers positioned between the core layer and the second skin layer. The second skin layer may be provided to improve the film's printability and lamination to other films or substrates.

The second skin layer comprises at least one polymer selected from the group consisting of a PE polymer, a PP polymer, an EP copolymer, an EPB terpolymer, an ethylene-vinyl alcohol (EVOH) polymer, a PB copolymer and blends thereof Preferably, the PE polymer is high-density polyethylene, such as HDPE, such as M-6211 and HDPE M-6030 (Equistar Chemical Company); and HD-6704.67 (ExxonMobil Chemical Company); and preferably the PP polymer is an EP copolymer, such as Total EP 8573 (Total Petrochemicals Company). For coating and printing functions, the second skin layer may preferably comprise a co- or terpolymer that has been surface treated. For metallizing or barrier properties, a HDPE, PP, PB, or EVOH may be preferred. A suitable EVOH copolymer is Eval G176B (Kuraray Company Ltd. of Japan).

The thickness of the second skin layer depends upon the intended function of the skin layer, but is typically in the range of from about 0.50 μm to about 3.5 μm; preferably from about 0.50 μm to about 2 μm; and in many forms most preferably from about 0.50 μm to about 1.5 μm. Also, in thinner film forms, the second skin layer thickness may range from about 0.50 μm to about 1.0 μm; or from about 0.50 μm to about 0.75 μm; or is about 0.50 μm.

### Second Tie Layer

In some forms of the multi-layer films invention, an optional second tie layer forms a region of the core layer that is in surface contact with the second skin layer. Such second tie layer forms the second surface of the core layer that is contiguous to the first surface of the second skin layer. In some preferred forms, the second tie layer is an adhesion promoting material, such as Admer AT 1179A (Mitsui Chemicals America Inc.), a maleic anhydride-modified polypropylene.

The thickness of the second tie layer is in the range of from about 1 μm to about 10 μm; preferably from about 1 μm to about 4 μm; and most preferably from about 2 μm to about 3 μm. In other embodiments, the thickness may be from about 0.5 μm to about 8 μm; or from about 1 μm to about 6 μm.

### Coating

In some forms, one or more coatings, such as for barrier, printing and/or processing, may be applied to the second skin layer of the multi-layer films disclosed herein. Such coatings may include acrylic polymers, such as ethylene acrylic acid (EAA), ethylene methyl acrylate copolymers (EMA), polyvinylidene chloride (PVdC), poly(vinyl)alcohol (PVOH) and ethylene (vinyl)alcohol EVOH. The coatings are preferably applied by an emulsion coating technique, but may also be applied by co-extrusion and/or lamination.

The PVdC coatings that are suitable for use with the multi-layer films of this invention are any of the known PVdC compositions heretofore employed as coatings in film manufacturing operations, e.g., any of the PVdC materials described in U.S. Pat. Nos. 4,214,039; 4,447,494; 4,961,992; 5,019,447; and 5,057,177, incorporated herein by reference.

Known vinyl alcohol-based coatings, such as PVOH and EVOH, which are suitable for use with the multi-layer films invention, include VINOL 125 or VINOL 325 (Air Products, Inc.). Other PVOH coatings are described in U.S. Pat. No. 5,230,963, incorporated herein by reference.

### Film Orientation

The forms of this invention include possible uniaxial or more preferably biaxial orientation of the multi-layer films. Orientation in the direction of extrusion is known as machine direction orientation (MD), orientation perpendicular to direction of extrusion is known as transverse direction (TD). Orientation may be accomplished by stretching or pulling a blown film in the MD, using a blow-up ratio to accomplish TD orientation. Blown films or cast films may also be oriented by a tenter-frame orientation subsequent to the film extrusion process, again in one or both directions. Orientation may be sequential or simultaneous, depending upon the desired film features. Orientation ratios may generally be in the range of 1:3-1:6 in the machine direction (MD) or 1:4-1:10 in the transverse direction (TD). Preferred orientation ratios are commonly from between about three to about six times in the machine direction and between about four to about ten times the extruded width in the transverse direction.

### Surface Treatment

One or more of the surfaces of the outer layers of the multi-layer films of this invention may be surface-treated to increase the surface energy to render the film receptive to metallization, coatings, printing inks, and/or lamination. The surface treatment can be carried out according to one of the methods known in the art. Methods that include, corona discharge, flame, plasma, chemical treatment, or treatment by means of a polarized flame.

### Metallization

The exterior surface of one or more of the second skin layers (or the core layer if no second skin layer is present) may be metallized. Such layers may be metallized using conventional methods, such as vacuum metallization by deposition of a metal layer such as aluminum, copper, silver, chromium, or mixtures thereof.

### Other Additives

Other additives that may be added to the multi-layer films of this invention, include, but are not limited to, pigments, colorants, anti-oxidants, anti-ozonants, anti-fogs, anti-stats, fillers such as diatomaceous earth, combinations thereof, and the like. Such additives may be used in effective amounts, which vary depending upon the property required, and are, typically selected from one or more of anti-block, slip additive, anti-oxidant additive, moisture barrier additive, or gas barrier additive.

Useful anti-static additives that may be used in amounts ranging from about 0.05 to 3 wt %, based upon the weight of the layer, include alkali metal sulfonates, polyether-modified polydiorganosiloxanes, polyalkylphenylsiloxanes, and tertiary amines

Anti-blocking agents, such as a silica-based product, such as Sylobloc 44 (Grace Davison Products); polymethyl methacrylate (PMMA) particles, such as EPOSTAR™; or polysiloxanes, such as TOSPEARL™; are also contemplated.

The sealant layer and/or the second skin layer may also include a non-migratory slip agent, such as polymethyl methacrylate (PMMA). The non-migratory slip agent may have a (mean) particle size in the range of from about 0.5 μm to about 13 μm, or more preferably from about 0.5 μm to about 10 μm, or from about 1 μm to about 6 μm, or from about 2 μm to about 4 μm, depending upon layer thickness and desired slip properties. Alternatively, the size of the particles in the non-migratory slip agent, such as PMMA, may be >20% of the thickness of the sealant or second skin layer containing the slip agent, or >40% of the thickness of the layer, or >50% of the thickness of the layer. In preferred embodiments, the size of the particles is >the layer thickness (e.g., about 110% to about 750%, preferably about 200% to about 400%) of the layer thickness. Generally spherical, particulate non-migratory slip additives are contemplated, including PMMA resins, such as EPOSTAR™, manufactured by Nippon Shokubai Co., Ltd. Other commercial sources of suitable materials are also known to exist. Non-migratory means that these particulates do not generally change location throughout the layers of the film in the manner of the migratory slip agents.

A conventional polydialkyl siloxane, such as silicone oil or gum additive, having a viscosity of 10,000 to 2,000,000 centistokes, is also contemplated.

Useful anti-oxidants are phenolic anti-oxidants, such as Irganox 1010 (Ciba-Geigy Company). Such anti-oxidants are generally used in amounts ranging from 0.1 to 2 wt %, based on the total weight of the layer to which it is added.

Barrier additives may be used in effective amounts and may include low-molecular weight resins, hydrocarbon resins, particularly petroleum resins, styrene resins, cyclopentadiene resins, and terpene resins.

### Substrate

A substrate is adhered to the surface of the multi-layer film opposite the sealant layer. Exemplary substrates include cellulosic and synthetic polymer materials. Exemplary cellulosic materials include, e.g., numerous varieties of paper such as corrugated paperboard, craft paper, glassine, and cartonboard. Exemplary polymeric substrate materials include non-woven tissue, e.g., spunbonded polyolefin fiber, melt-blown microfibers, etc. In some embodiments, the polymeric material is an oriented film comprising polypropylene or polyester. Particular polymeric films include a metallized polypropylene film with heat sealable layer, or a polyester having a melting point of 175° C. to 200° C. Some embodiments may employ a suitable adhesive to bond the multi-layer film to the substrate. Thus, in some embodiments, the multi-layer film or the substrate includes an adhesive layer to form the surface contact between the multi-layer polymeric film and the substrate. Exemplary adhesives include hot melt adhesives, e.g., low density polyethylene, ethylene-methacrylate copolymers, polyvinylidene chloride latexes, polyurethanes, and acrylic coatings.

### Heat Seals

Heat seals useful in packaging are commonly lap, fin, or crimp seals. Most frequently, vertical form fill and seal and/or horizontal form fill and seal (VFFS and/or HFFS, respectively) useful in snack packaging will employ a fin seal and two crimp seals. Films of the present invention are particularly suitable for forming lap seals.

### Methods and Uses

Multi-layer films disclosed herein are useful as substantially stand-alone film webs or they may be coated, metallized, and/or laminated to other film structures. Multi-layer films disclosed herein may be prepared by any suitable methods that comprise the steps of co-extruding a multi-layer film according to the description and claims of this specification, orienting and preparing the film for intended use such as by coating, printing, slitting, or other converting methods. Preferred methods comprise co-extruding, then casting and orienting, or blowing a five-layer film, such as illustrated and discussed in the examples and in this specification.

In one form, a method of preparing a multi-layer film is provided. The method comprises the step of co-extruding a core layer having a first surface and a second surface, the core layer comprising a core polymer and a sealant layer adjacent the first surface of the first tie layer, the sealant layer comprising an anti-blocking agent and having a 45° surface gloss ≦20.0, wherein a top seal and/or side seal of the sealant layer to itself has a seal strength >about 5.0×10², e.g., 5.0×10² to 6.0×10², grams per inch at 127° C.

In another form, a method of preparing a multi-layer film is provided. The method comprises co-extruding at least a core layer having a first surface and a second surface, the core layer comprising a core polymer, a first polymeric tie layer having a first surface and a second surface, the second surface of the first tie layer adjacent the first surface of the core layer, the first tie layer and a polymeric sealant layer adjacent the first surface of the first tie layer, the sealant layer having a 45° surface gloss ≦20.0, enclosing a product or article within at least a portion of the co-extruded film, engaging a first portion of the sealant skin layer with a second portion of the sealant skin layer at a seal layer and applying pressure and heat at the seal area to cause the first portion to engage with the second portion to create at least top seal and/or side seal, the top seal and/or side seal of the sealant layer to itself has a seal strength >about 5.0×10², e.g., 5.0×10² to 6.0×10², grams per inch at 127° C. The prepared multi-layer film may be used as a flexible packaging film, such as to package an article or good, such as a food item or other product. In some applications, the film may be formed into bags for snack foods.

### Property Measurements

Heat seal strength is a measure of the force required to separate a test strip of a material containing a seal and identifies the mode of failure of the test strip. The seal strength is generally performed on a surface that is sealed to itself. The film may or may not be laminated prior to the test. A sealing machine such as a Lako Tool seal machine is used to create the seal and measure the seal strength. A one-inch strip of the film or lamination is cut and folded seal face to seal face. The strip is mounted on the sample holder which automatically inserts the folded strip between the seal jaws. The jaws, which can have a crimp pattern or can be flat, then come together with a set pressure and temperature to create the heat seal. The seal strength is measured automatically by a device which separates the layers of film and measures the force required to open the seal.

Minimum seal temperature (MST) is a measure of the sealing property of a film and is the temperature at which a heat seal may support a given force. The seal range is the maximum temperature that the structure seals prior to severe distortion due to sealing heat, minus the MST.

Gloss is a measure of the luster of a surface. The film to be measured is put on a black background. An incident light beam strikes the surface of the film at a 45° angle. A sensor measures the amount of light that is reflected by the film. The gloss is the ratio of the reflected light to the incident light expressed as a value generally between 0 and 100 although values greater than 100 are possible. A BYK Gardner Mini-gloss 45° is one instrument used to measure gloss.

The kinetic coefficient of friction (“COF”) was determined according to ASTM 1895 with 25 seconds of measuring time using a TMI Model 32-06 lab slip and friction testing equipment (commercially available from Testing Machines Inc. of Ronkonkoma, N.Y.). A 200 g sled comprised of 3/16 inch sponge rubber with 17 to 24 psi compressibility, is preferred.

The surface roughness (Ra) of the film samples were measured using a surface profilometer (Mahr Federal Perthometer M2 with PFM Drive Unit) according to ISO 4287. The film sample to be tested should be wrinkle and contamination free. Multiple locations are measured across the sample in the TD. The pick-up (stylus) is placed in the measuring position. The tracing-arm is placed on the sample so that the stylus pulls across the TD of the sample surface to be measured. Testing is performed from the right edge of the film surface to center to left edge of the film, in order to prevent contamination of the testing area from the stylus. The Ra value is the arithmetic average of the absolute values of the roughness profile ordinates of the film's surface.

The Mahr Federal Perthometer was also used to determine the peak count (Pc) of the film. The peak count is a unitless measure of the number of roughness profile elements per one inch (2.54 cm) of film. Even though the stylus will travel over a shorter distance, the instrument uses a ratio-and-proportion algorithm to determine what the counts would be over one inch (2.54 cm). In order to determine the peak count, a bandwith of ±0.51 μm was used for the bandwidth that is symmetrical about the mean line for a total bandwith of 1.02 μm. To be counted as a peak, the peak and valley combination must pass through both the top and bottom of this bandwith.

Sealing strength and range can be measured on a vertical form, fill and seal (VFFS) packaging machine. An example is the Hayssen™ Ultima II available from Hayssen Packaging Technologies. The outer web, the outside of the final package, is first laminated to an appropriate inner web such as 70 MET-HB available from ExxonMobil Chemical Company. The film can be laminated using a water-based or solvent-based adhesive or an extruded polyethylene-based layer. This lamination is run through the packaging machine at 72 empty packages per minute. The lamination is formed into a cylinder by the forming collar and this cylinder runs along a tube that is normally used for filling the package. The end seal is created using reciprocating heated jaws with horizontal serrations which compress and apply heat to the ends of the formed cylinder. The back seal or lap seal, where the inside surface has to seal to the outside surface, is made using a heated reciprocating platen that applies heat and pressure to the overlapped film layers and the fill tube on the machine. The crimp or lap seal strength is measured by cutting a 25 mm wide sample across the seal and measuring the force required to peel apart the seal using an Alfred-Suter seal strength testing machine. For the lap seal the minimum sealing temperature (MST) is achieved when the platen temperature causes the seal strength to exceed 100 g/25 mm. For the crimp seal, the MST is achieved when the crimp jaw temperature causes the seal strength to exceed 200 g/25 mm. The ultimate seal temperature (UST) is the temperature that causes the lamination to distort too severely to measure a seal strength. The seal range is the difference between the UST and the MST.

Force over forming color (FOFC) can also be measured on a VFFS machine. A Mira Pak Mira-matic Model L is set-up with a laminated structure as described above. The lamination is threaded over a forming collar, a device which forms the lamination into a cylinder prior to sealing and filling. Rather than seal and fill the structure, in this test the lamination is pulled through the machine and the force required to pull the film is measured using a force gauge such as a Dillon electronic force gauge made by W.C. Dillon & Company. Through forming the package, the friction between outer web and the forming collar changes the force required to pull the lamination through the machine. A ‘good’ outer web will generate a low FOFC, while a ‘bad’ outer web will have a higher FOFC.

Hot slip is measured on the Mira Pak by creating a back seal at a set temperature and then measuring FOFC. On a Mira Pak the back seal is created by overlapping the ends of the formed cylinder so the inside and outside of the lamination are facing each other. This overlapped area slides between two platens, one of which is heated. With the addition of this heat, the force required to pull the lamination through the machine normally increases. With a good outer web the force required will not increase substantially when the heat is increased.

### Particular Embodiments

1. Embodiments of the invention include a multi-layer structure, comprising:

(a) an oriented multi-layer polymeric film, comprising:
(i) a heat sealable skin layer comprising a matte resin composition and 0.5 to <50.0 wt % of an elastomer selected from propylene based elastomers, ethylene-based elastomers and mixtures thereof, wherein the elastomer or mixture thereof has a Vicat softening temperature >50° C.; wherein the heat sealable skin layer has a Haze ≧45.0% and a 45° Gloss <20.0. and
(ii) a core layer comprising a polypropylene homopolymer or mini-random copolymer in surface contact with the heat sealable skin layer;

(b) optionally, a substrate in surface contact with the oriented multi-layer polymeric film.
2. In particular embodiments, the multi-layer structure of Embodiment 1 includes a heat sealable skin layer that has a minimum seal temperature ≦124° C. (255° F.).
3. In particular embodiments, the multi-layer structure of Embodiment 1 or 2 the heat sealable skin layer has a minimum seal temperature of 93° C. (200° F.) to 107° C. (225° F.).
4. Embodiments include multi-layer structures according to any of Embodiments 1 to 3, wherein the heat sealable skin layer has a kinetic coefficient of friction (when the coefficient of friction is measured against itself) of ≦0.80, ≦0.70, ≦0.60, ≦0.50, ≦0.40, or ≦0.30, particularly between 0.30 and 0.50.
5. Embodiments include multi-layer structures according to any of Embodiments 1 to 4, wherein the matte resin composition includes HDPE and a polymer selected from one or more LDPE polymer or copolymer, one or more ethylene-propylene copolymers, one or more ethylene-propylene-butylene terpolymers, and mixtures thereof.
6. Embodiments of the invention include multi-layer structures according to Embodiments 1 to 5 wherein the elastomer comprises a propylene-based elastomer comprising units derived from ethylene and <1.0 wt % of units derived from butene.
7. Embodiments of the invention include multi-layer structures according to Embodiments 1 to 6 wherein the heat sealable skin layer comprises 5.0 to 35.0 wt % of the propylene-based elastomer, wherein the propylene based elastomer has a Vicat softening temperature of 50.0° C. to 85.0° C.
8. Embodiments of the invention include multi-layer structures according to Embodiments 1 to 7, wherein the heat sealable skin layer comprises a propylene-based elastomer having an isotactic propylene triad tacticity of from 65 to 95%, a melting point by DSC ≦110° C., a heat of fusion of from 5.0 to 50.0 J/g, the propylene-based elastomer comprising:

(i) propylene-derived units in an amount of at least 75 wt. %; based on the combined weight of components (i), (ii), and (iii);

(ii) ethylene-derived units in an amount of at least 6 wt. %, based on the combined weight of components (i), (ii), and (iii); and

(iii) optionally 10 wt. % or less of diene-derived units, based on the combined weight of components (i), (ii), and (iii).
9. Embodiments of the invention include multi-layer structures according to Embodiment 8, wherein the propylene-based elastomer comprises <18.0 wt %, particularly 15.0 to 18.0 wt % ethylene-derived units, based on the combined weight of components (i), (ii), and (iii).
10. Embodiments of the invention include multi-layer structures according to Embodiments 1 to 5, wherein the heat sealable skin layer comprises an ethylene-based elastomer comprising 1.0 to 35 wt % of polymer units derived from a C₃-C₂₀ comonomer and has a composition distribution breadth index (CDBI) >90%, a density of 0.86 g/cm³ to 0.925 g/cm³, and a melt index of 0.1 to 100 dg/min according to ASTM D1238 at 190° C. under a load of 2.16 kg.
11. Embodiments of the invention include multi-layer structures according to Embodiment 10, wherein the elastomer comprises an ethylene-based elastomer comprising 1.0 to 10.0 wt % of polymer units derived butene, hexene, or octene and having a composition distribution breadth index (CDBI) >95%, a density of 0.86 g/cm³ to 0.90 g/cm³, and a melt index of 1.0 to 8.0 dg/min according to ASTM D1238 at 190° C.
12. Embodiments of the invention include multi-layer structures according to Embodiment 10, wherein the ethylene based elastomer comprises 1.0 to 10.0 wt % of polymer units derived from butene and <1.0 wt % of units derived from hexene and/or octene.
13. Embodiments of the invention include multi-layer structures according to any of Embodiments 1 to 12, further comprising a second skin layer on a side of the core layer opposite the heat sealable skin layer.
14. Embodiments of the invention include multi-layer structures according to Embodiment 13, wherein the second skin layer comprises at least one of a propylene homopolymer, a propylene copolymer, a propylene terpolymer, a polyethylene, and/or a polyethylene copolymer.
15. Embodiments of the invention include multi-layer structures according to Embodiment 14, wherein the second skin layer is corona discharge or flame treated.
16. Embodiments of the invention include multi-layer structures according to any of Embodiments 13 to 15, wherein the oriented multi-layer film further includes a coating on the second skin layer.
17. Embodiments of the invention include multi-layer structures according to Embodiment 16, wherein the basis weight of the coating on the second skin layer is about 0.1 g/m² to about 4.0 g/m².
18. Embodiments of the invention include multi-layer structures according to any of Embodiments 1 to 17, wherein the core layer is cavitated.
19. Embodiments of the invention include multi-layer structures according to Embodiment 18, wherein the cavitated core layer comprises polybutylene terephthalate; calcium carbonate; nylon; or preformed glass, metal, or ceramic spheres.
20. Embodiments of the invention include multi-layer structures according to Embodiment 19, wherein said polybutylene terephthalate of said core layer comprises at most about 15 wt % of the core layer.
21. Embodiments of the invention include multi-layer structures according to Embodiments 1 to 20, wherein the heat sealable skin layer further includes ≦3.00×10³ parts per million silicone oil.
22. Embodiments of the invention include multi-layer structures according to Embodiments 1 to 21, wherein the substrate comprises an unmetallized oriented polymeric film, a metallized oriented polymeric film, or a cellulosic material.
23. Particular embodiments relate to a multi-layer structure, comprising:

(a) an oriented multi-layer polymeric film, comprising:
(i) a heat sealable skin layer comprising an incompatible polymer blend, wherein the incompatible polymer blend comprises 70.0 to 95.0 wt % of a matte resin comprising HDPE and a propylene based polymer, and 5.0 to 30.0 wt % of a propylene-ethylene elastomer, wherein the propylene-ethylene elastomer has density ≦0.880 g/cm³, a Vicat softening temperature of 50.0° C. to 85.0° C. and comprises 6.0 to 18.0 wt %. polymer units derived from ethylene and <1.0 wt % polymer units derived from monomers other than propylene, wherein the heat sealable skin layer has a Haze ≧45.0% and a 45° Gloss <20.0;
(ii) a core layer comprising a polypropylene homopolymer or mini-random copolymer in surface contact with the heat sealable skin layer;

(b) optionally, a substrate in surface contact with the multi-layer polymeric film.
24. Embodiments of the invention include multi-layer structures according to Embodiment 23, wherein the propylene-ethylene elastomer has an isotactic propylene triad tacticity of from 65 to 95%, a melting point by DSC ≦110° C., and a heat of fusion of from 5.0 to 50.0 J/g.
25. Particular embodiments relate to a multi-layer structure, comprising:

(a) an oriented multi-layer polymeric film, comprising:
(i) a heat sealable skin layer comprising an incompatible polymer blend, wherein the incompatible polymer blend comprises 80.0 to 95.0 wt % of a matte resin comprising HDPE and an ethylene-propylene-butylene terpolymer, and 5.0 to 20.0 wt % of a ethylene-butylene elastomer, having a density ≦0.880 g/cm³, a Vicat softening temperature of 50.0° C. to 85.0° C. and comprises <1.0 wt % polymer units derived from monomers other than ethylene and butene, wherein the heat sealable skin layer has a Haze ≧45.0% and a 45° Gloss <20.0;
(ii) a core layer comprising a polypropylene homopolymer or mini-random copolymer in surface contact with the heat sealable layer;

(b) optionally, a substrate in surface contact with the multi-layer polymeric film.
26. Embodiments of the invention include multi-layer structures according to Embodiment 25, wherein the ethylene-butylene elastomer has a composition distribution breadth index (CDBI) >95%, a density of 0.86 g/cm³ to 0.90 g/cm³, and a melt index of 1.0 to 8.0 dg/min according to ASTM D1238 at 190° C.
27. Embodiments of the invention include multi-layer structures according to Embodiment 25, where in the incompatible polymer blend includes 85.0 to 95.0 wt % of a matte resin comprising HDPE and an ethylene-propylene-butylene terpolymer, and 5.0 to 15.0 wt % of a ethylene-butylene elastomer,
28. Embodiments of the invention also relate to a method of making a heat sealable multi-layer structure, the method comprising:

a) coextruding a multi-layer polymeric film comprising i) a heat sealable skin layer comprising a matte resin composition and 0.5 to <50.0 wt. % of a propylene- or ethylene-based elastomer and ii) core layer comprising a polypropylene homopolymer or mini-random copolymer;

b) orienting the multi-layer polymeric film in the machine and/or transverse direction; and

c) optionally, laminating a substrate to a side of the multi-layer polymeric film opposite the heat sealable skin layer.
29. Embodiments of the invention include multi-layer structures according to Embodiment 28, further including quenching the coextruded multi-layer polymeric film utilizing a chilled casting roll system or casting roll and water bath system. Quenching is preferably performed prior to orientation.
30. Embodiments of the invention also relate to articles comprising the multi-layer structure of any of Embodiments 1 to 28 or the film made by any of Embodiments 28 to 29.

### EXPERIMENTAL

The multi-layer film of the present invention will be further described with reference to the following non-limiting examples. All weight percentages specified herein are based on the weight of the respective film layer, unless specified otherwise.

### Example 1

A film structure is prepared from a three layer coextruded biaxially oriented film having layers A, B, and C in an A/B/C arrangement. Layer A is a 1.5 μm sealable layer comprising 90.0 wt % of XPM3140, a blend of high density polyethylene (HDPE) and an ethylene-propylene-butylene terpolymer (EPB) available from Japan Polypropylene, and 10.0 wt % Tafmer XM7070, a propylene-butylene copolymer, based on the wt. of Layer A. The core layer, Layer B, has a thickness of 15.6 μm and comprises polypropylene homopolymer, e.g., polypropylene grades PP4712 and/or 3371, from ExxonMobil Chemical Company and Total Petrochemicals, respectively. Layer C is a cast roll skin having a thickness of 0.64 μm and comprising high ethylene content polypropylene 8573HB from Total Petrochemicals. Layer C is flame treated to a surface energy of 40 dyne. Representative properties of the film of Example 1 are reported in Table 1.

### Example 2

In this example, the film of Example 1 is substantially repeated with the exception that an ethylene-based butylene plastomer from ExxonMobil Chemical Company (Exact™ 4049) is used in place of the Tafmer XM7070 propylene-butylene copolymer. The ethylene-based butylene plastomer has a Vicat Softening Point of 55.0° C. (131° F.) (according to ASTM D1525), a density of 0.873 g/cm³, a melt index of 4.5 g/10 min. (according to ASTM D1238 at 2.16 kg and 190° C.), a peak melting temperature of 52.8° C. (127° F.), and a crystallization peak temperature, Tc, of 41° C. (106° F.). Representative properties of the film of Example 2 are reported in Table 1.

### Example 3

In this example, the film of Example 1 is substantially repeated with the exception that a propylene-based elastomer from ExxonMobil Chemical Company (Vistamaxx™ 6102) is used in place of the Tafmer XM7070 propylene-butylene copolymer. The propylene-based elastomer has an ethylene content of 16.0 wt %, a Vicat Softening Point of 58.9° C., a density of 0.862 g/cm³, a melt index of 1.3 g/10 min. (according to ASTM D1238 at 2.16 kg and 190° C.), and a MFR of 3.0 (according to ASTM D1238 at 2.16 kg and 230° C.). Representative properties of the film of Example 3 are reported in Table 1.

### Example 4

In this example, the film of Example 1 is substantially repeated with the exception that the XPM3140 HDPE/EPB blend is replaced with XPM3420, a different HDPE/EPB blend, from Japan Polypropylene Corporation. Representative properties of the film of Example 4 are reported in Table 1.

### Example 5

In this example, the film of Example 2 is substantially repeated with the exception that the XPM3140 HDPE/EPB blend is replaced with the HDPE/EPB blend XPM3420. Representative properties of the film of Example 5 are reported in Table 1.

### Example 6

In this example, the film of Example 3 is substantially repeated with the exception that the XPM3140 HDPE/EPB blend is replaced with the HDPE/EPB blend XPM3420. Representative properties of the film of Example 6 are reported in Table 1.

### Example 7

The film of Example 1 is substantially repeated except that layer A is a 1.5 μm sealable layer comprising 85.0 wt % Matif 55, a matte resin available from Ampacet Corp., and 15.0 wt % the propylene-based elastomer, Vistamaxx™ 6102, based on the weight of Layer A. Representative properties of the film of Example 7 are reported in Table 1.

### Example 8

The film of Example 7 is substantially repeated except that layer A comprises 84.85 wt % Matif 55, 15.0 wt % the propylene-based elastomer, Vistamaxx™ 6102, and 0.15 wt % polymethylmethyacrylate, available as Epostar MA-1004 from Nippon Shokubai, weight percentages are based on the total weight of Layer A. Representative properties of the film of Example 8 are reported in Table 1.

### Example 9

The film of Example 7 is substantially repeated except that layer A comprises 77.1 wt % Matif 55, and 22.9 wt % a propylene-based elastomer having an ethylene content of 10.5 wt %, a Vicat Softening Point of 70.0° C., a density of 0.879 g/cm³, a melt index of 0.90 g/10 min. (according to ASTM D1238 at 2.16 kg and 190° C.), and a MFR of 2.2 (according to ASTM D1238 at 2.16 kg and 230° C.), Vistamaxx™ 3020 from ExxonMobil Chemical Company, weight percentages are based on the total weight of Layer A. Representative properties of the film of Example 9 are reported in Table 1.

### Example 10

The film of Example 7 is substantially repeated except that layer A comprises 71.65 wt % Matif 55, 28.2 wt % a propylene-based elastomer having an ethylene content of 8.5 wt %, a Vicat Softening Point of 80.0° C., a density of 0.874 g/cm³, a melt index of 3.6 g/10 min. (according to ASTM D1238 at 2.16 kg and 190° C.), and a MFR of 8.3 (according to ASTM D1238 at 2.16 kg and 230° C.), available as Vistamaxx™ 3980 from ExxonMobil Chemical Company, and 0.15 wt % Tospearl T120 (a polysiloxane from GE Bayer Silicones of Wilton, Conn.), weight percentages are based on the total weight of Layer A. Representative properties of the film of Example 10 are reported in Table 1.

### Example 11

The film of Example 10 is substantially repeated except that layer A comprises 78.725 wt % Matif 55, 21.200 wt % the propylene-based elastomer Vistamaxx™ 3980, and 0.075 wt % Epostar MA-1004, weight percentages are based on the total weight of Layer A. Representative properties of the film of Example 10 are reported in Table 1.

### Comparative Example 1

In this comparative example, the film of Example 1 is substantially repeated with the exception that Layer A comprises 100.0 wt % HDPE/EPB blend, based on the weight of Layer A. Representative properties of the film of Comparative Example 1 are reported in Table 1.

### Comparative Example 2

In this comparative example, the film of Example 1 is substantially repeated with the exception that Layer A comprises 100.0 wt % Matif 33 (Ampacet Corporation of Tarrytown, N.Y., USA), based on the weight of Layer A. Representative properties of the film of Comparative Example 2 are reported in Table 1.

### Comparative Example 3

In this comparative example, the film of Example 1 is substantially repeated with the exception that Layer A comprises 50.0 wt % HDPE (Total Petrochemical 6410 HDPE) and 50.0 wt % ethylene-butylene copolymer (Tafmer XM7070), based on the weight of Layer A. Representative properties of the film of Comparative Example 3 are reported in Table 1.

### Comparative Example 4

In this comparative example, the film of Comparative Example 1 is substantially repeated with the exception that Layer A comprises 50.0 wt % of a different HDPE (Total Petrochemical 6410 HDPE) and 50.0 wt % of a propylene-based elastomer (Vistamaxx™ 3980), based on the weight of Layer A. Representative properties of the film of Comparative Example 4 are reported in Table 1.

TABLE 1
Film Compositions

| | Layer A | | | | | |
|---|---|---|---|---|---|---|
| | | | Blend Component | | | |
| | | | (Comonomer Content, | | | |
| Example | Base Resin | Wt % | wt %) | Wt % | Layer B | Layer C |
| 1 | XPM3140 | 90.0 | Tafmer ™ XM7070 | 10.0 | h-PP | P/E copolymer |
| 2 | XPM3140 | 90.0 | Exact ™ 4049 | 10.0 | h-PP | P/E copolymer |
| 3 | XPM3140 | 90.0 | Vistamaxx ™ 6102 (16.0) | 10.0 | h-PP | P/E copolymer |
| 4 | XPM3420 | 90.0 | Tafmer ™ XM7070 | 10.0 | h-PP | P/E copolymer |
| 5 | XPM3420 | 90.0 | Exact ™ 4049 | 10.0 | h-PP | P/E copolymer |
| 6 | XPM3420 | 90.0 | Vistamaxx ™ 6102 (16.0) | 10.0 | h-PP | P/E copolymer |
| 7 | Matif 55 | 85.0 | Vistamaxx ™ 6102 (16.0) | 15.0 | h-PP | P/E copolymer |
| 8 | Matif 55 | 84.85 | Vistamaxx ™ 6102 (16.0) | 15.0 | h-PP | P/E copolymer |
| 9 | Matif 55 | 77.1 | Vistamaxx ™ 3020 (10.5) | 22.9 | h-PP | P/E copolymer |
| 10 | Matif 55 | 71.65 | Vistamaxx ™ 3980 (8.5) | 28.2 | h-PP | P/E copolymer |
| 11 | Matif 55 | 78.725 | Vistamaxx ™ 6102 (8.5) | 21.2 | h-PP | P/E copolymer |
| CE 1 | XPM3420 | 100 | — | — | h-PP | P/E copolymer |
| CE 2 | Matif 33 | 100 | — | — | h-PP | P/E copolymer |
| CE 3 | Total 6410 HDPE | 50 | Tafmer ™ XM7070 | 50 | h-PP | P/E copolymer |
| CE 4 | Total 6420 HDPE | 50 | Vistamaxx ™ 3980 (8.5) | 50 | h-PP | P/E copolymer |

TABLE 2
Film Properties

| | Lako MST | | Lako MST | | Lako flat MST to 70 MET | | Haze, | 45° | COF |
|---|---|---|---|---|---|---|---|---|---|
| Example | vertical†, ° C. (° F.) | | flat††, ° C. (° F.) | | sealant†††, ° C. (° F.) | | % | Gloss | kinetic |
| 1 | 112 | (234) | >126 | (>260) | >126 | (>260) | 59.0 | 15.0 | 0.654 |
| 2 | 107 | (225) | 123 | (253) | 123.8 | (254.8) | 54.0 | 15.4 | 0.710 |
| 3 | 106 | (223) | 122 | (252) | 122.0 | (251.6) | 61.9 | 12.1 | 0.635 |
| 4 | 107 | (224) | 124 | (255) | 125.8 | (258.5) | 60.2 | 14.3 | 0.732 |
| 5 | 103 | (217) | 119 | (247) | 118.4 | (245.2) | 46.8 | 17.8 | 0.746 |
| 6 | 103 | (218) | 121 | (250) | 122.3 | (252.1) | 59.0 | 12.7 | 0.753 |
| 7 | 101 | (214) | | | 117.8 | (244.0) | 64.7 | 10.8 | 0.80 |
| 8 | 102 | (216) | | | 117.3 | (243.2) | 61.5 | 11.2 | 0.38 |
| 9 | 103 | (217) | | | | | 61.1 | 11.5 | 0.76 |
| 10 | 98.9 | (210) | | | | | 60.7 | 12.3 | 0.845 |
| 11 | 102 | (215) | | | | | 65.3 | 10.4 | 0.562 |
| CE 1 | 109 | (228) | >126 | (>260) | >126 | (>260) | 58.3 | 15.4 | 0.685 |
| CE 2 | 113 | (235) | >126 | (>260) | 125.6 | (258.0) | 70 | 10.4 | 0.727 |
| CE 3 | 74.4 | (166) | 83.9 | (183) | 98.94 | (210.1) | 25.3 | 33.6 | 0.830 |
| CE 4 | 74.4 | (166) | 80.0 | (176) | 91.28 | (196.3) | 12.3 | 57.1 | 1.243 |

†Lako vertical seals were run with two-side heat, 60 psi, 0.75 second dwell, 20 seconds cooling before measurement, using the vertical patterned crimp jaws.
††Lako flat seals were run with one-side heat, 25 psi, 0.5 second dwell, 20 second cooling with the flat seal jaw.
†††Lako flat seals with matte sealant layer sealed to 70MET sealant, an EPB terpolymer with Tₘ = 122.5° C.

Examples 5 and 6 demonstrate that use of propylene-based elastomer and ethylene-based butene plastomer in combination with the HDPE/EPB terpolymer blend substantially reduces the vertical minimum seal temperature (MST). The more challenging flat seals, run at low pressures, also show a significant reduction in minimum seal temperature. The use of propylene-butylene copolymer surprisingly provides a film with acceptable optical properties and improved minimum sealing temperature when used in combination with HDPE/EPB blends. Examples 1-3 demonstrate that the minimum seal temperature of a relatively high temperature sealing matte resin like XPM3140 can be improved with the appropriate choice of blend component.

To obtain a practical measure of machining properties, Examples 7-11 are subjected to force over forming collar (FOFC) and hot slip measurements.

TABLE 3
Hayssen Seal, FOFC, and Hot Slip Measurements

| | Hayssen | Hayssen | | Mir-Pak |
|---|---|---|---|---|
| | Short Dwell Lap | Short Dwell | | Hot Slip at |
| | Seal range, | MST, | Mira-Pak | 143° C. |
| Example | ° C. (° F.) | ° C. (° F.) | FOFC, lb_{f} | (290° F.), lb_{f} |
| 1 | 12 (20) | 154 (310) | | |
| 2 | 17 (30) | 149 (300) | | |
| 3 | 23 (40) | 143 (290) | 24 | |
| 4 | 23 (40) | 143 (290) | 25 | |
| 5 | 23 (40) | 143 (290) | 28 | |
| 6 | 28 (50) | 138 (280) | 27 | |
| 7 | 28 (50) | 143 (280) | 31-36 | 33-37 |
| 8 | 23 (40) | 143 (290) | 25 | 27 |
| 9 | 28 (50) | 138 (280) | 31-35 | 32-35 |
| 10 | 28 (50) | 138 (280) | 31-38 | 33-45 |
| 11 | 28 (50) | 138 (280) | 25-30 | 26-30 |

Examples 7 and 8 show lower MST's than even Example 6, while maintaining higher haze and lower gloss. The packaging results confirm the good lap seal performance. Example 8 is further improved by the addition of 4 micron PMMA antiblock (i.e. Epostar MA-1004), which lowered the COF to a more desirable range. The lower COF translated well to machining behavior, resulting in excellent Mira-Pak FOFC and hot slip performance.

Examples 9-11 illustrate that lower ethylene content and higher softening temperature are surprisingly equivalent or even better than propylene-based elastomers with higher ethylene content at providing good sealablity in these matte resin blends, without detrimental effect on MST values. Packaging results confirmed excellent lap sealability and optical properties for these examples. While Example 11 has a 25% lower level of Vistamaxx 3980 (i.e., 1.8% C₂ content in blend), the film still provides excellent seal performance, as evidenced by 215° F. MST and 50° F. lap seal range on the Hayssen packaging machine, as well as excellent optical properties. These results are surprising, because higher crystallinity and softening point resins are expected to negatively affect sealability. The results showing that they were effective at even lower overall ethylene comonomer concentrations are particularly surprising.

To the extent that this description is specific, it is solely for the purpose of illustrating certain forms of the invention and should not be taken as limiting the present inventive concepts to these specific forms. Therefore, the spirit and scope of the appended claims should not be limited to the description of the forms contained herein.

All patents, test procedures, and other documents cited herein, including priority documents, are fully incorporated by reference to the extent such disclosure is not inconsistent and for all jurisdictions in which such incorporation is permitted.

While the illustrative forms disclosed herein have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all inventive features which reside herein, including all features which would be treated as equivalents thereof by those skilled in the art to which this disclosure pertains.

When numerical lower limits and numerical upper limits are listed herein, ranges from any lower limit to any upper limit are contemplated.

1. A multi-layer structure, comprising:
(a) an oriented multi-layer polymeric film, comprising:
(i) a heat sealable skin layer comprising a matte resin composition and 0.5 to <50.0 wt. % of an elastomer selected from propylene based elastomers, ethylene-based elastomers and mixtures thereof, wherein the elastomer or mixture thereof has a Vicat softening temperature ≧50.0° C.; wherein the heat sealable skin layer has a Haze ≧45.0% and a 45° Gloss <20.0, and
(ii) a core layer comprising a polypropylene homopolymer or mini-random copolymer in surface contact with the heat sealable skin layer;
(b) optionally, a substrate in surface contact with the oriented multi-layer polymeric film.

2. The multi-layer structure of claim 1, wherein the heat sealable skin layer has a minimum seal temperature ≦124° C. (255° F.).

3. The multi-layer structure of claim 1, wherein the heat sealable skin layer has a minimum seal temperature of 93° C. (200° F.) to 107° C. (225° F.).

4. The multi-layer structure of claim 1, wherein the heat sealable skin layer has a kinetic coefficient of friction ≦0.80, when measured against itself.

5. The multi-layer structure of claim 4, wherein the kinetic coefficient of friction is 0.30 to 0.50.

6. The multi-layer structure of claim 1, wherein the matte resin composition includes HDPE and a polymer selected from one or more LDPE polymer or copolymer, one or more ethylene-propylene copolymers, one or more polypropylene homopolymer, ethylene and/or butylene-containing propylene based polymers, and mixtures thereof

7. The multi-layer film structure of claim 1, wherein the elastomer comprises a propylene-based elastomer comprising units derived from ethylene and <1.0 wt % of units derived from butene.

8. The multi-layer film structure of claim 1, wherein the heat sealable skin layer comprises 5.0 to 35.0 wt % of the propylene-based elastomer, wherein the propylene based elastomer has a Vicat softening temperature of 50.0° C. to 85.0° C.

9. The multi-layer structure of claim 1, wherein the heat sealable skin layer comprises a propylene-based elastomer having an isotactic propylene triad tacticity of from 65 to 95%, a melting point by DSC ≦110° C., a heat of fusion of from 5.0 to 50.0 J/g, the propylene-based elastomer comprising:
(i) propylene-derived units in an amount of at least 75 wt %; based on the combined weight of components (i), (ii), and (iii);
(ii) ethylene-derived units in an amount of at least 6 wt %, based on the combined weight of components (i), (ii), and (iii); and
(iii) optionally 10 wt % or less of diene-derived units, based on the combined weight of components (i), (ii), and (iii).

10. The multi-layer film structure of claim 9, wherein the propylene-based elastomer comprises <18.0 wt % ethylene-derived units.

11. The multi-layer film structure of claim 10, wherein the propylene-based elastomer comprises >15.0 wt % ethylene-derived units.

12. The multi-layer structure of claim 1, wherein the heat sealable skin layer comprises an ethylene-based elastomer comprising 1 to 35 wt % of polymer units derived from a C₃-C₂₀ comonomer and has a composition distribution breadth index (CDBI) >90%, a density of 0.86 to 0.925 g/cm³, and a melt flow rate of 0.1 to 100 dg/min, measured according to ASTM D1238 at 230° C./2.16 kg.

13. The multi-layer film structure of claim 12, wherein the elastomer comprises an ethylene-based elastomer comprising 1.0 to 10.0 wt % of polymer units derived from butene, hexene, or octene and having a composition distribution breadth index (CDBI) >95%, a density of 0.86 to 0.90 g/cm³, and a melt index of 1.0 to 8.0 dg/min, measured according to ASTM D1238 at 190° C./2.16 kg.

14. The multi-layer film structure of claim 13, wherein the ethylene based elastomer comprises 1.0 to 10.0 wt % of polymer units derived from butene and <1.0 wt % of units derived from hexene and/or octene.

15. The multi-layer structure of claim 1, further comprising a second skin layer on a side of the core layer opposite the heat sealable skin layer.

16. The multi-layer structure of claim 15, wherein the second skin layer comprises at least one of a propylene homopolymer, a propylene copolymer, a propylene terpolymer, a polyethylene, and/or a polyethylene copolymer.

17. The multi-layer structure of claim 16, wherein the second skin layer is corona discharge or flame treated.

18. The multi-layer structure of claim 15, wherein the oriented multi-layer film further includes a coating on the second skin layer.

19. The multi-layer structure of claim 16, wherein the basis weight of the coating on the second skin layer is about 0.1 g/m² to about 4.0 g/m².

20. The multi-layer structure according claim 1, wherein at least a portion of the core layer is cavitated.

21. The multi-layer structure according to claim 20, wherein the cavitated portion of the core layer comprises polybutylene terephthalate; calcium carbonate; nylon; or preformed glass, metal or ceramic spheres.

22. The multi-layer structure according to claim 21, wherein said polybutylene terephthalate of said core layer comprises at most about 15 wt % of the cavitated portion of the core layer.

23. The multi-layer structure of claim 1, wherein the heat sealable skin layer further includes ≦3.0×10³ parts per million silicone oil.

24. The multi-layer structure of claim 1, wherein the substrate comprises an unmetallized oriented polymeric film, a metallized oriented polymeric film, or a cellulosic material.

25. A multi-layer structure, comprising:
(a) an oriented multi-layer polymeric film, comprising:
(i) a heat sealable skin layer comprising an incompatible polymer blend, wherein the incompatible polymer blend comprises 80.0 to 95.0 wt % of a matte resin comprising HDPE and an ethylene-propylene-butylene terpolymer, and 5.0 to 20.0 wt % of a propylene-ethylene elastomer, wherein the propylene-ethylene elastomer has density ≦0.880 g/cm³, a Vicat softening temperature of 50.0° C. to 85.0° C. and comprises 6.0 to 18.0 wt %, polymer units derived from ethylene and <1.0 wt % polymer units derived from monomers other than propylene and ethylene, wherein the heat sealable skin layer has a Haze ≧45.0% and a 45° Gloss <20.0;
(ii) a core layer comprising a polypropylene homopolymer or mini-random copolymer in surface contact with the heat sealable skin layer;
(b) optionally, a substrate in surface contact with the multi-layer polymeric film.

26. The multi-layer structure claim 25, wherein the propylene-ethylene elastomer has an isotactic propylene triad tacticity of from 65 to 95%, a melting point by DSC ≦110° C., a heat of fusion of from 5.0 to 50.0 J/g.

27. A multi-layer structure, comprising:
(a) an oriented multi-layer polymeric film, comprising:
(i) a heat sealable skin layer comprising an incompatible polymer blend, wherein the incompatible polymer blend comprises 80.0 to 95.0 wt % of a matte resin comprising HDPE and an ethylene-propylene-butylene terpolymer, and 5.0 to 20.0 wt % of a ethylene-butylene elastomer, having a density ≦0.880 g/cm³, a Vicat softening temperature 50° C. to 85° C. and comprises <1.0 wt % polymer units derived from monomers other than ethylene and butene, wherein the heat sealable skin layer has a Haze ≧45.0% and a 45° Gloss <20.0;
(ii) a core layer comprising a polypropylene homopolymer or mini-random copolymer in surface contact with the heat sealable layer;
(b) optionally, a substrate in surface contact with the multi-layer polymeric film.

28. The multi-layer structure of claim 27, wherein the ethylene-butylene elastomer has a composition distribution breadth index (CDBI) >95%, a density of 0.86 to 0.90 g/cm³, and a melt index of 1.0 to 8.0 dg/min measured according to ASTM D1238 at 230° C./2.16 kg.

29. The multi-layer structure of claim 27, wherein the incompatible polymer blend includes 85.0 to 95.0 wt % of a matte resin comprising HDPE and an ethylene-propylene-butylene terpolymer, and 5.0 to 15.0 wt % of a ethylene-butylene elastomer,

30. A method of making a heat sealable multi-layer structure, the method comprising:
a) coextruding a multi-layer polymeric film comprising i) a heat sealable skin layer comprising a matte resin composition and 0.5 to <50.0 wt % of a propylene- or ethylene-based elastomer; and ii) core layer comprising a polypropylene homopolymer or mini-random copolymer;
b) orienting the multi-layer polymeric film in the machine and/or transverse direction; and
c) optionally, laminating a substrate to a side of the multi-layer polymeric film opposite the heat sealable skin layer.

31. The method of claim 30, further including quenching the coextruded multi-layer polymeric film utilizing a chilled casting roll system or casting roll and water bath system.

32. An article comprising the multi-layer structure of claim 1.
